(19) United States
(12) Patent Application Publication
(10) Pub. No.: US 2016/0298902 A1
(43) Pub. Date: Oct. 13, 2016

(54) Vacuum Pipeline System

(71) Applicants: BOE TECHNOLOGY GROUP CO., LTD, Beijing (CN); BEIJING BOE DISPLAY TECHNOLOGY CO., LTD., Beijing (CN)

(72) Inventors: Jianfeng WANG, Beijing (CN); Peng CHEN, Beijing (CN); Zhenqi YOU, Beijing (CN); Lei ZHU, Beijing (CN); Kaimin WU, Beijing (CN); Xiaoliang WANG, Beijing (CN)

(21) Appl. No.: 15/097,664

(22) Filed: Apr. 13, 2016

(30) Foreign Application Priority Data
Apr. 13, 2015 (CN) 201510173279.8

(51) Int. Cl. F26B 5/12; F16K 31/12; F16K 31/06; F16K 1/22

(52) U.S. Cl. CPC F26B 5/12; F16K 1/22; F16K 31/12; F16K 31/06

(57) ABSTRACT

A vacuum pipeline system is provided. The vacuum pipeline system includes a dry pump and a vacuum dry chamber, a first valve and a second valve, and an air open system. The dry pump is connected to the vacuum dry chamber through a vacuum pipeline. The first valve and the second valve are disposed on the vacuum pipeline. The air open system is for injecting air into the vacuum pipeline, and is disposed on the vacuum pipeline and between the first valve and second valve.

### CROSS REFERENCE TO RELATED APPLICATIONS

This application claims priority to China patent application number 201510173279.8, which was filed on Apr. 13, 2015, the disclosure of which is incorporated by reference herein in its entirety.

### BACKGROUND

Embodiments of the present disclosure relate to the display technical field, more particularly, to a vacuum pipeline system.

Currently, a VCD (vacuum chamber dry) vacuum pipeline system is as shown in FIG. 1: a dry pump 1 is connected to a vacuum dry chamber 2 through a vacuum pipeline 3, and a first valve 4 (main valve) and a second valve 5 (butterfly valve) are disposed on the vacuum pipeline 3. After evacuation is completed, a large amount of organic substances are found attached on the three points of A, B, and C in the vacuum pipeline system. These three points can be referred to as a first attaching area A, a second attaching area B and a third attaching area C. The three areas are where the condition of organic substances attachment is severe. When organic substances are attached to the vacuum pipeline, it will cause corrosion and leakage of an O-ring in the main valve, thus affecting the effect of VCD evacuation, prolonging the VCD processing time, and prolonging the production line cycle time and causing abnormal quality.

### BRIEF DESCRIPTION

(1) Technical Problem to be Solved

The technical problem to be solved by the embodiments of present disclosure is to provide a vacuum pipeline system which can reduce the likelihood of organic substances being attached to the vacuum pipeline and in the main valve, prolonging the life of the main valve, and reducing the costs.

(2) Technical Solutions

In order to solve the above technical problem, embodiments of the present disclosure provide a vacuum pipeline system, which includes: a dry pump and a vacuum dry chamber, the dry pump being connected to the vacuum dry chamber through a vacuum pipeline; a first valve and a second valve being disposed on the vacuum pipeline; and an air open system for injecting air into the vacuum pipeline being disposed on the vacuum pipeline and between the first valve and the second valve.

According to an exemplary embodiment of the system described herein, the air open system includes a gas supply pipeline, a third valve, and a control unit; wherein an output end of the gas supply pipeline is connected to the vacuum pipeline, and its output end is between the first valve and the second valve; wherein the third valve is disposed on the gas supply pipeline; and wherein the control unit is for controlling opening and closing of the third valve.

According to an exemplary embodiment of the system described herein, an input end of the gas supply pipeline is connected to a gas source, which is for generating inert gas.

According to an exemplary embodiment of the system described herein, an input end of the gas supply pipeline is connected to the air.

According to an exemplary embodiment of the system described herein, the third valve is a pneumatic valve; wherein the control unit includes a PLC controller, an electromagnetic valve, and a power source; and a gas input pipeline is disposed between the power source and the third valve, and the power source is for inputting compressed air into the gas supply pipeline; wherein the electromagnetic valve is disposed on the gas input pipeline, and wherein the PLC controller is electrically connected to the electromagnetic valve.

According to an exemplary embodiment of the system described herein, a filter is disposed on the gas supply pipeline and between its output end and the third valve.

According to an exemplary embodiment of the system described herein, a first ventilation unit and a second ventilation unit are disposed on the vacuum dry chamber; wherein the first ventilation unit is for injecting air into the vacuum dry chamber; and wherein the second ventilation unit is for injecting compressed air into the vacuum dry chamber.

According to an exemplary embodiment of the system described herein, the first valve includes a housing, a driving switch and a sealing part; wherein an upstream valve port and downstream valve port are disposed on the housing, the upstream valve port being connected to the vacuum dry chamber, the downstream valve port being connected to the dry pump; wherein the driving switch is disposed within the housing, for connecting or disconnecting the upper valve port and the downstream valve port; and wherein the sealing part is disposed between the driving switch and the housing.

According to an exemplary embodiment of the system described herein, the second valve is a butterfly valve, and is disposed between the vacuum dry chamber and the first valve.

(3) Advantageous Effects

The above technical solutions of the present disclosure have at least the following advantageous effects: embodiments of the present disclosure provide a vacuum pipeline system, with an air open system added on the vacuum pipeline, and inject gas into the vacuum pipeline through the air open system, thus reducing the likelihood that organic substances are attached to the vacuum pipeline and the main valve, prolonging the life of the main value and reducing the costs.

### BRIEF DESCRIPTION OF THE DRAWINGS

FIG. 1 is a structural schematic view of a prior-art vacuum pipeline system;

FIG. 2 is a structural schematic view of a vacuum pipeline system according to an embodiment of the present disclosure;

FIG. 3 is a structural schematic view of the first valve according to an embodiment of the present disclosure.

FIG. 4 is an action timing diagram of the modified VCD (vacuum chamber dry) according to an embodiment of the present disclosure.

FIG. 5 is a chart illustrating the costs difference before and after modification according to an embodiment of the present disclosure.

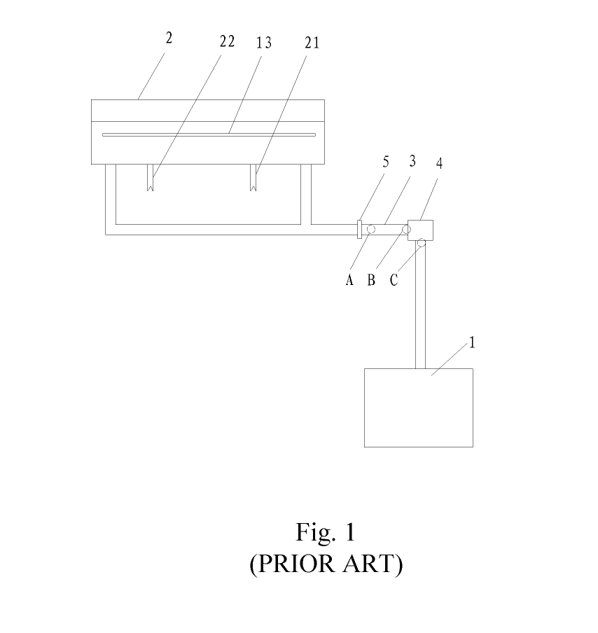

### DETAILED DESCRIPTION

The following will further describe implementations of the present disclosure in conjunction with the accompanying drawings and the embodiments. The following embodiments are merely for illustrating illustrative purposes, and are not intended to restrict the scope of the present disclosure.

In the description of the present embodiments, it should be noted that, unless otherwise stated, “a plurality of” means two or more than two; the orientational or positional relationships denoted by the terms of “up”, “low”, “left”, “right”, “inner”, “outer”, “front”, “back”, “head”, and “end” are based on the orientational or positional relationships shown in the accompanying drawings, and are merely for describing the present embodiments and simplifying the description, rather than indicating or implying that the stated device or element must have the specific orientation, or be constructed and operated in the specific orientation, and thus cannot be understood as a restriction on the present disclosure. In addition, the terms of “first”, “second”, or “third” are merely for the purpose of description, and cannot be understood as indicating or implying any relative importance.

In the description of the present embodiments, it should be further noted that unless otherwise specified and restricted clearly, the terms of “install”, “connect”, “connecting” should be understood in a broad sense; e.g., it may be a fixed connection, or a removable connection, or a integral connection; it may be a mechanic connection, or an electric connection; it may be a direct connection, or an indirect connection through an intermediate medium. For those of ordinary skilled in the art, the specific meanings of the above terms in the present disclosure may be understood depending on the specific contexts.

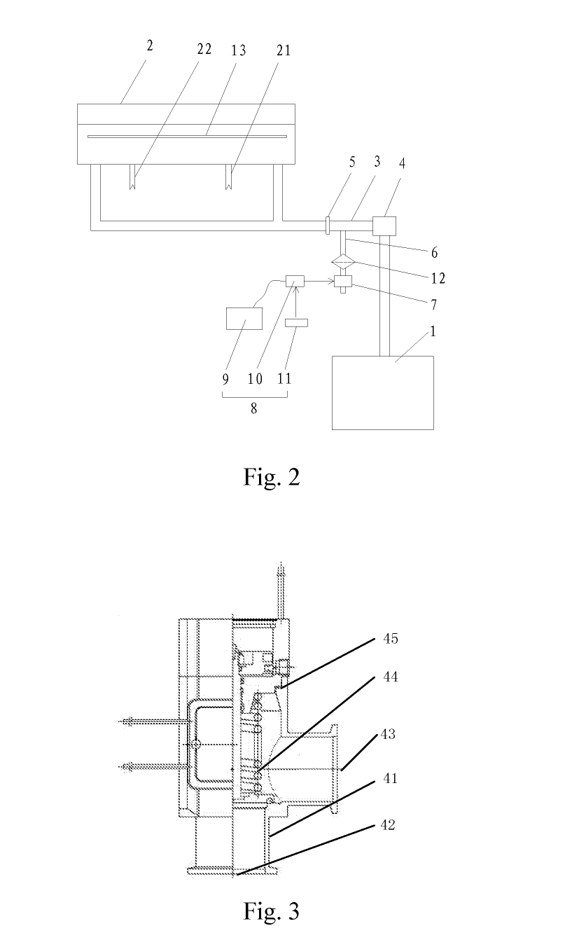

As shown in FIG. 2, the vacuum pipeline system provided by this embodiment comprises a dry pump 1 and a vacuum dry chamber 2, and the dry pump 1 is connected to the vacuum dry chamber 2 through a vacuum pipeline 3; a first valve 4 and a second valve 5 are disposed on the vacuum pipeline 4, and an air open system is disposed on the vacuum pipeline 3 and between the first valve 4 and the second valve 5. The air open system is for injecting air into the vacuum pipeline 3, thus reducing the likelihood that organic substances are attached to the vacuum pipeline 3 and first valve 4 (main valve), prolonging the life of the main valve and reducing the costs.

According to an exemplary embodiment of the system described herein, the air open system includes a gas supply pipeline 6, a third valve 7 and a control unit 8; an output end of the gas supply pipeline 6 is connected to the vacuum pipeline 4, between the first valve 4 and the second valve 5, and for inputting gas; a third valve 7 is disposed on the gas supply pipeline 6; a control unit 8 is connected to the third valve 7, and may automatically control the open and close of the third valve 7 as needed, thus realizing automatic setting.

According to a further exemplary embodiment of the system described herein, a filter 12 is disposed on the gas supply pipeline 6 and between its output end and the third valve 7. The gas in the gas supply pipeline 6 is filtered by the filter 12; the filter 12 may be a simple filter screen, or a multi-phase gas filtering apparatus. The type of filter is not restricted to the embodiments included herein.

In addition, according to a further exemplary embodiment of the system described herein, there may be two gas sources that can be used by the air open system: inert gas or air; when an inert gas (e.g., nitrogen) is selected to be injected into the gas supply pipeline 6, correspondingly, the input end of the gas supply pipeline 6 needs to be independently connected to a gas source for generating the inert gas, wherein the gas is relatively pure, and suitable to be used by the filter 12 for a long time.

And when air is selected to be injected into the gas supply pipeline 6, the input end of the gas supply pipeline 6 may be directly connected to the air, without need to introduce a separate gas source; however, it should be noted that the filter 12 needs to be replaced periodically to remove impurities.

The form of the third valve 7 in this embodiment is not restricted, and may be selected flexibly according to actual needs.

According to a further exemplary embodiment of the system described herein, when the third valve 7 is a pneumatic valve, correspondingly the control unit comprises a PLC controller 9, an electromagnetic valve 10 and a power source 11; a gas input pipeline is disposed between the power source 11 and the third valve 7, and the power source 11 is for inputting compressed air into the gas input pipeline, so as to drive the pneumatic valve; the electromagnetic valve 10 is disposed on the gas input pipeline and between the power source 11 and the third valve 7, for controlling the supply and cutoff of the compressed air; the PLC controller 9 is electrically connected to the electromagnetic valve 10 through a signal line for controlling the open and close of the electromagnetic valve 10.

According to an exemplary embodiment of the system described herein, a first ventilation unit 21 and a second ventilation unit 22 are disposed on the vacuum chamber 2; the first ventilation unit 21 is connected to the air, for injecting air into the vacuum dry chamber 2, eliminating the pressure difference between the vacuum dry chamber 2 and the outside, and the vacuum dry chamber 2 can only be opened when it returns to the atmospheric pressure, so that substrate 13 can be extracted.

Moreover, the second ventilation unit 22 is connected to a gas source, and the second ventilation unit 22 may inject compressed air into the vacuum dry chamber 2 through the gas source, and its function is: when the air pressure in the vacuum dry chamber 2 is approaching the atmospheric pressure, the air pressure rising is slow, and by injecting compressed air through the second ventilation unit 22, the vacuum dry chamber 2 may rapidly return to the atmospheric pressure.

According to a further exemplary embodiment of the system described herein, as shown in FIG. 3, the first valve 4 is used as the main valve of the vacuum pipeline 3, and includes a housing 41, a driving switch 44 and a sealing part 45; an upstream valve port 42 and a downstream valve port 43 are disposed on the housing 41; the upstream valve port 42 is connected to the vacuum dry chamber 2, and the downstream valve port 43 is connected to the dry pump 1; the driving switch 44 is disposed within the housing 41, for connecting or disconnecting the upstream valve port 42 and the downstream valve port 42, wherein the driving switch 44 includes parts such as a cylinder, a shaft group etc.; the sealing part 45 is disposed between the driving switch 44 and housing 41, using an O-ring to seal.

In addition, according to a further exemplary embodiment of the system described herein, the second valve 5 is a butterfly valve, and is between the vacuum dry chamber 3 and the first valve 4, for controlling fast evacuation and slow evacuation during the evacuation.

Embodiments of the present disclosure further provides a method of preventing organic substances from being attached to a vacuum pipeline, the method includes the following steps:

S1: placing a substrate coated with photoresist into the vacuum dry chamber, opening the first valve and the second valve to evacuate the vacuum dry chamber, and the third valve is in an always-closed state during the evacuation;

S2: after the evacuation is finished, closing the first valve and the second valve at the same time; then opening the third valve, and the gas input pipeline automatically inputs gas into the vacuum pipeline as effected by the pressure difference;

S3: opening the first ventilation unit and the second ventilation unit, and extracting the substrate after the vacuum dry chamber returns to the atmospheric pressure.

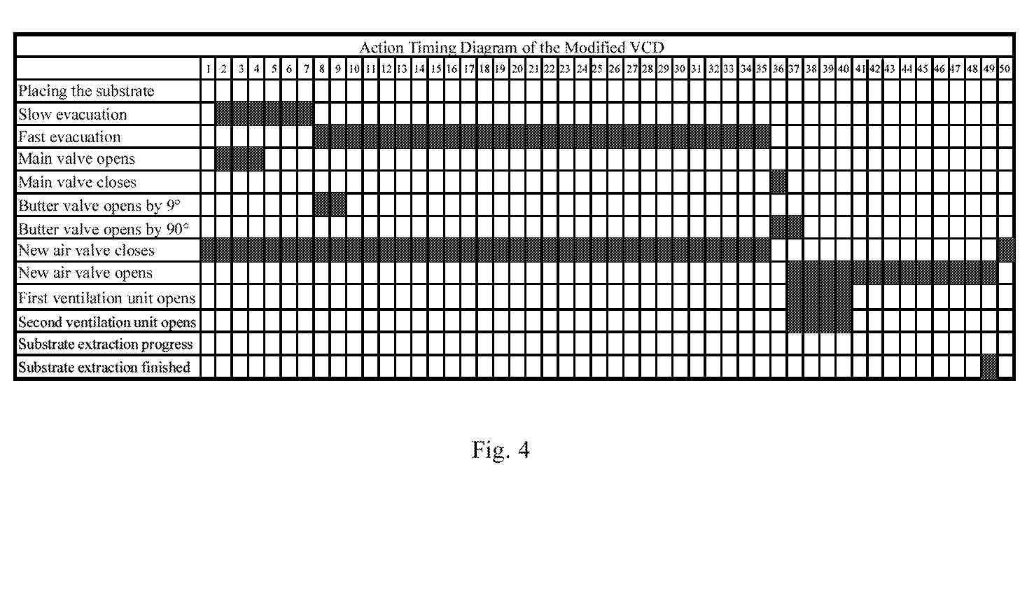

Specifically, for example, this may be illustrated in conjunction with the timing diagram shown in FIG. 4.

First, when the substrate is placed into the vacuum dry chamber, the first valve (main valve) opens, and the second valve (butterfly valve) opens by 9° to perform slow evacuation; when the air pressure reaches about 60,000 Pa, the butterfly valve opens by 90° to perform fast evacuation, and the fast evacuation is finished after the air pressure reaches about 10 Pa; during the process, the third valve (air valve) is always in a closed state.

After the evacuation is finished, the main valve and the butterfly valve close at the same time, and the third valve (air valve) opens; due to the pressure difference, nitrogen or air will enter into the closed space between the main valve and the butterfly valve through the gas supply pipeline to reduce the relative concentration of the organic gas in the space, thus reducing the likelihood that organic substances are attached to the vacuum pipeline and the main valve, i.e., reducing the collision probability of the organic gas molecules, prolonging the life of the main valve, and achieving the objective of reducing costs.

Meanwhile, the first ventilation unit and the second ventilation unit open to make the vacuum dry chamber un-vacuumed, and the substrate is extracted after the vacuum dry chamber returns to the atmospheric pressure.

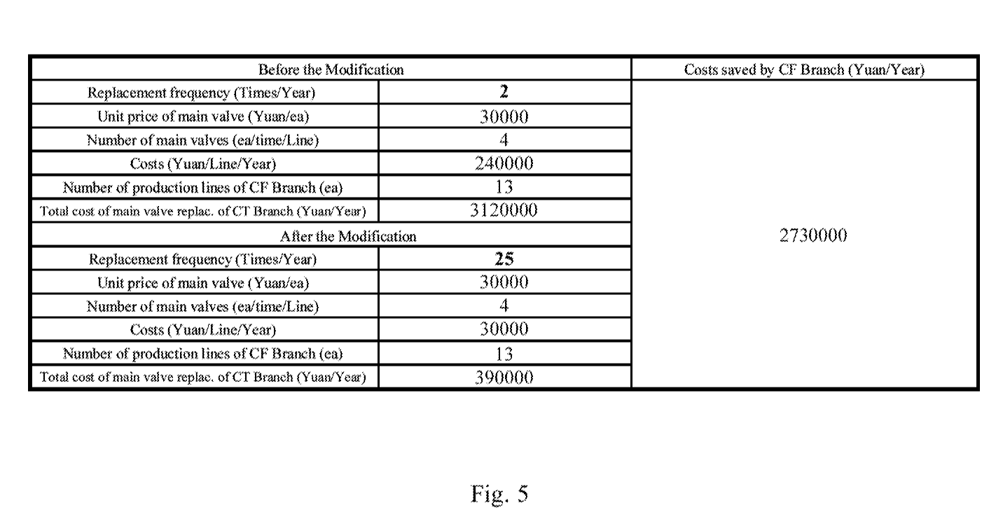

After the above modified solution is implemented, the attachment ratio of organic volatile substances in the vacuum pipeline is decreased prominently. For example, before and after the modification, a branch factory saves costs, as shown in FIG. 5. FIG. 5 illustrates the replacement frequency of the main valve reduced from once per half year to once per four years on average, thus greatly saving on maintenance costs. Such cost savings make implementing this modified solution suitable for wide application.

To sum up, embodiments of the present disclosure provide a vacuum pipeline system, which adds an air open system on the vacuum pipeline system; gas is input into the vacuum pipeline through the air open system, thus reducing the likelihood that organic substances are attached to the vacuum pipeline and the main valve, prolonging the life of the main valve, and saving the costs.

Embodiments of the present disclosure are given for the sake of illustration and description, rather than being exhaustive or restricting the present disclosure to the disclosed form. Many modifications and changes are obvious for those of ordinary skilled in the art. The embodiments are selected and descried to better explain the principles and the practical application of the present disclosure, and to make those of ordinary skilled in the art to understand the present invention in order to design various embodiments with various modifications suitable for specific purposes.

1. A vacuum pipeline system, comprising:
a dry pump and a vacuum dry chamber, the dry pump being connected to the vacuum dry chamber through a vacuum pipeline;
a first valve and a second valve being disposed on the vacuum pipeline; and
an air open system for injecting air into the vacuum pipeline being disposed on the vacuum pipeline and between the first valve and the second valve.

2. The vacuum pipeline system of claim 1, wherein the air open system comprises a gas supply pipeline, a third valve, and a control unit;
wherein an output end of the gas supply pipeline is connected to the vacuum pipeline, and the output end is between the first valve and the second valve;
wherein the third valve is disposed on the gas supply pipeline; and
wherein the control unit is for controlling opening and closing of the third valve.

3. The vacuum pipeline system of claim 2, wherein an input end of the gas supply pipeline is connected to a gas source, the gas source being used to generate inert gas.

4. The vacuum pipeline system of claim 2, wherein an input end of the gas supply pipeline is connected to air.

5. The vacuum pipeline system of claim 2, wherein the third valve is a pneumatic valve;
wherein the control unit comprises a programmable logic controller (PLC) controller, an electromagnetic valve, and a power source;
wherein a gas input pipeline is disposed between the power source and the third valve, the power source being for inputting compressed air into the gas input pipeline;
wherein the electromagnetic valve is disposed on the gas input pipeline; and
wherein the PLC controller is electrically connected to the electromagnetic valve.

6. The vacuum pipeline system of claim 2, wherein a filter is disposed on the gas supply pipeline and between the output end of the gas supply pipeline and the third valve.

7. The vacuum pipeline system of claim 1, wherein a first ventilation unit and a second ventilation unit are disposed on the vacuum dry chamber;
wherein the first ventilation unit is for injecting air into the vacuum dry chamber; and
wherein the second ventilation unit is for injecting compressed air into the vacuum dry chamber.

8. The vacuum pipeline system of claim 1, wherein the first valve comprises a housing, a driving switch and a sealing part;
wherein an upstream valve port and downstream valve port are disposed on the housing, the upstream valve port being connected to the vacuum dry chamber, the downstream valve port being connected to the dry pump;
wherein the driving switch is disposed within the housing, for connecting or disconnecting the upper valve port and the downstream valve port; and
wherein the sealing part is disposed between the driving switch and the housing.

9. The vacuum pipeline system of claim 1, wherein the second valve is a butterfly valve, and is disposed between the vacuum dry chamber and the first valve.
